(19) United States
(12) Patent Application Publication
(10) Pub. No.: US 2015/0206395 A1
(43) Pub. Date: Jul. 23, 2015

(54) SYSTEMS AND METHODS FOR MANAGING LOYALTY ACCOUNTS

(71) Applicant: FIRST DATA CORPORATION, Greenwood Village, CO (US)

(72) Inventor: Alan L. Chung, New York, NY (US)

(21) Appl. No.: 14/598,562

(22) Filed: Jan. 16, 2015

Related U.S. Application Data
(60) Provisional application No. 61/928,867, filed on Jan. 17, 2014.

(51) Int. Cl. G07F 17/32

(52) U.S. Cl. CPC G07F 17/3255

(57) ABSTRACT

Systems, devices, methods, computer-readable media, techniques, and methodologies are disclosed for managing loyalty accounts. In some embodiments, a server may receive a merchant ID associated with a merchant and consumer information associated with a user via a mobile device of the user. The server may determine a location of the user based at least in part on the merchant ID. The server may obtain information associated with at least one consumer loyalty account based at least in part on the consumer information. The server may determine at least one offer for transmission to the mobile device of the user or to a point of sale device associated with the merchant.

### CROSS-REFERENCE TO RELATED APPLICATION

This application claims the benefit of U.S. Provisional Application No. 61/928,867, filed Jan. 17, 2014, entitled “Systems and Methods for Managing Loyalty Accounts,” the contents of which are hereby incorporated by reference.

### FIELD OF THE DISCLOSURE

The disclosure generally relates to processing account information, and more particularly relates to systems and methods for managing loyalty accounts.

### BACKGROUND

Consumers may have multiple loyalty accounts associated with multiple merchants at any given time. Due to the quantity of loyalty accounts and merchants and certain conventional technologies available for using loyalty accounts, it may be difficult for consumers and merchants to manage and keep track of various information associated with those loyalty accounts.

### BRIEF DESCRIPTION OF THE DISCLOSURE

This disclosure relates to systems and methods for managing loyalty accounts. In one embodiment, a method may include receiving, by a server including one or more processors, a merchant ID associated with a merchant and further receiving consumer information associated with a user via a mobile device of the user; determining, by the server, a location of the user based at least in part on the merchant ID; obtaining, by the server, information associated with at least one consumer loyalty account based at least in part on the consumer information; and determining, by the server, at least one offer for transmission to the mobile device of the user or to a point of sale device associated with the merchant.

In one aspect of an embodiment, the method may include receiving, by the server, user input from the mobile device indicative of an acceptance or rejection of the at least one offer. In one aspect of an embodiment, the method may include receiving, by the server, payment information from a transaction with the merchant and associated with the user; and correlating, by the server, the transaction with the at least one consumer loyalty account. In one aspect of an embodiment, the method may include determining, by the server, based at least in part on the payment information, a payment amount associated with the transaction; and adjusting, by the server, the payment amount based at least in part on a user selection of one or more offers or one or more gift cards associated with the consumer loyalty account. In one aspect of an embodiment, the method may include receiving, by the server, payment information associated with the user from a transaction with the merchant, wherein at least a portion of the payment information is associated with the at least one consumer loyalty account. In one aspect of an embodiment, the method may include at least one of transmitting, by the server, the at least one offer to the mobile device of the user; or transmitting, by the server, the at least one offer to a point of sale device associated with the merchant. In one aspect of an embodiment, transmitting the at least one offer to the point of sale device may include transmitting at least one of a deducted amount for a total bill associated with the user, transmitting a percentage discount for the total bill, transmitting a deducted amount from a gift card balance associated with the user, transmitting a coupon for a discounted or free product or service, or transmitting an advertisement. In one aspect of an embodiment, receiving a merchant ID may further include receiving, by the server, the merchant ID via an application executing on the mobile device of the user, wherein the application transmits the merchant ID to at least one loyalty management server or payment processing server. In one aspect of an embodiment, receiving consumer information may further include receiving, by the server, the consumer information via an application executing on the mobile device of the user, wherein the application transmits the consumer information to at least one loyalty account server or payment processing server. In one aspect of an embodiment, obtaining information associated with the at least one consumer loyalty account may further include retrieving, by the server, previously stored consumer loyalty account information using the received consumer information.

In another embodiment, a system may include at least one memory storing computer-executable instructions; and at least one processor, wherein the at least one processor may be configured to access the at least one memory and to execute the computer-executable instructions to receive a merchant ID associated with a merchant and to further receive consumer information associated with a user via a mobile device of the user; determine a location of the user based at least in part on the merchant ID; obtain information associated with at least one consumer loyalty account based at least in part on the consumer information; and determine at least one offer for transmission to the mobile device of the user or to a point of sale device associated with the merchant.

In one aspect of an embodiment, the at least one processor may be configured to access the at least one memory and to further execute the computer-executable instructions to receive user input from the mobile device indicative of an acceptance or rejection of the at least one offer. In one aspect of an embodiment, the at least one processor may be configured to access the at least one memory and to further execute the computer-executable instructions to receive payment information from a transaction with the merchant and associated with the user; and correlate the transaction with the at least one consumer loyalty account. In one aspect of an embodiment, the at least one processor may be configured to access the at least one memory and to further execute the computer-executable instructions to determine based at least in part on the payment information, a payment amount associated with the transaction; and adjust the payment amount based at least in part on a user selection of one or more offers or one or more gift cards associated with the consumer loyalty account. In one aspect of an embodiment, the at least one processor may be configured to access the at least one memory and to further execute the computer-executable instructions to receive payment information associated with the user from a transaction with the merchant, wherein at least a portion of the payment information is associated with the at least one consumer loyalty account. In one aspect of an embodiment, the at least one processor may be configured to access the at least one memory and to further execute the computer-executable instructions to at least one of transmit the at least one offer to the mobile device of the user; or transmit the at least one offer to a point of sale device associated with the merchant. In one aspect of an embodiment, to transmit the at least one offer to the point of sale device, the at least one processor may be configured to access the at least one memory and to further execute the computer-executable instructions to transmit at least one of a deducted amount for a total bill associated with the user, transmit a percentage discount for the total bill, transmit a deducted amount from a gift card balance associated with the user, transmit a coupon for a discounted or free product or service, or transmit an advertisement. In one aspect of an embodiment, to receive a merchant ID, the at least one processor may be configured to access the at least one memory and to further execute the computer-executable instructions to receive the merchant ID via an application executing on the mobile device of the user, wherein the application transmits the merchant ID to at least one loyalty management server or payment processing server. In one aspect of an embodiment, to receive consumer information, the at least one processor may be configured to access the at least one memory and to further execute the computer-executable instructions to receive the consumer information via an application executing on the mobile device of the user, wherein the application transmits the consumer information to at least one loyalty account server or payment processing server. In one aspect of an embodiment, to obtain information associated with the at least one consumer loyalty account, the at least one processor may be configured to access the at least one memory and to further execute the computer-executable instructions to retrieve previously stored consumer loyalty account information using the received consumer information.

In another embodiment, a computer-readable medium storing computer-executable instructions which, when executed by a processor, may cause the processor to perform operations including receiving, by a server including one or more processors, a merchant ID associated with a merchant and further receiving consumer information associated with a user via a mobile device of the user; determining, by the server, a location of the user based at least in part on the merchant ID; obtaining, by the server, information associated with at least one consumer loyalty account based at least in part on the consumer information; and determining, by the server, at least one offer for transmission to the mobile device of the user or to a point of sale device associated with the merchant.

In one aspect of an embodiment, the operations may include receiving, by the server, user input from the mobile device indicative of an acceptance or rejection of the at least one offer. In one aspect of an embodiment, the operations may include receiving, by the server, payment information from a transaction with the merchant and associated with the user; and correlating, by the server, the transaction with the at least one consumer loyalty account. In one aspect of an embodiment, the operations may include determining, by the server, based at least in part on the payment information, a payment amount associated with the transaction; and adjusting, by the server, the payment amount based at least in part on a user selection of one or more offers or one or more gift cards associated with the consumer loyalty account. In one aspect of an embodiment, the operations may include receiving, by the server, payment information associated with the user from a transaction with the merchant, wherein at least a portion of the payment information is associated with the at least one consumer loyalty account. In one aspect of an embodiment, the operations may include at least one of transmitting, by the server, the at least one offer to the mobile device of the user; or transmitting, by the server, the at least one offer to a point of sale device associated with the merchant. In one aspect of an embodiment, transmitting the at least one offer to the point of sale device may include transmitting at least one of a deducted amount for a total bill associated with the user, transmitting a percentage discount for the total bill, transmitting a deducted amount from a gift card balance associated with the user, transmitting a coupon for a discounted or free product or service, or transmitting an advertisement. In one aspect of an embodiment, receiving a merchant ID may further include receiving, by the server, the merchant ID via an application executing on the mobile device of the user, wherein the application transmits the merchant ID to at least one loyalty management server or payment processing server. In one aspect of an embodiment, receiving consumer information may further include receiving, by the server, the consumer information via an application executing on the mobile device of the user, wherein the application transmits the consumer information to at least one loyalty account server or payment processing server. In one aspect of an embodiment, obtaining information associated with the at least one consumer loyalty account may further include retrieving, by the server, previously stored consumer loyalty account information using the received consumer information.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an example system for managing loyalty accounts in accordance with one or more example embodiments.

FIG. 2 illustrates a data flow diagram for managing loyalty accounts in accordance with one or more example embodiments.

FIG. 3 illustrates a flow diagram of an example data flow for managing loyalty accounts in accordance with one or more example embodiments.

FIG. 4 illustrates a flow diagram of another example method for managing loyalty accounts in accordance with one or more example embodiments.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like, but not necessarily the same or identical, elements throughout. Hence, if a feature is used across several drawings, the number used to identify the feature in the drawing where the feature first appeared will be used in later drawings.

### DETAILED DESCRIPTION

### Overview

Described herein are systems and methods for managing loyalty accounts. Broadly, the systems and methods described herein may facilitate the access of one or more loyalty accounts in response to receiving broadcast information from a radio beacon associated with a merchant. The systems and methods describe herein may further facilitate the association of consumer purchase transactions with loyalty account information.

Thus, according to one or more embodiments of the disclosure, a method is provided for managing loyalty accounts. The method may include receiving a merchant ID and consumer information via a consumer's mobile device. The method may also include determining, based at least in part on the merchant ID, the consumer's location. Furthermore, the method may include obtaining, based at least in part on the consumer information, information associated with at least one consumer loyalty account. Additionally, the method may include determining, based at least in part on the information associated with the at least one consumer loyalty account, at least one offer for transmission to the consumer's mobile device or to a point of sale device associated with the merchant.

According to one or more other embodiments of the disclosure, a system is provided for managing loyalty accounts. The system may include at least one memory for storing data and computer-executable instructions. The system may also include at least one processor to access the at least one memory and to execute the computer-executable instructions. The at least one processor may be configured to execute the instructions to receive a merchant ID and consumer information via a consumer's mobile device. The at least one processor may also be configured to execute the instructions to determine, based at least in part on the merchant ID, the consumer's location. The at least one processor may further be configured to execute the instructions to obtain, based at least in part on the consumer information, information associated with at least one consumer loyalty account. Additionally, the at least one processor may further be configured to execute the instructions to determine, based at least in part on the information associated with the at least one consumer loyalty account, at least one offer for transmission to the consumer's mobile device or to a point of sale device associated with the merchant.

According to one or more other embodiments of the disclosure, a non-transitory computer-readable medium is provided. The computer-readable medium may store computer-executable instructions, that when executed by at least one processor, causes the at least one processor to receive a merchant ID and consumer information via a consumer's mobile device. The computer-readable medium may store further instructions that cause the at least one processor to determine, based at least in part on the merchant ID, the consumer's location. Furthermore, the computer-readable medium may store instructions that cause the at least one processor to obtain, based at least in part on the consumer information, information associated with at least one consumer loyalty account. The computer-readable medium may also store instructions that cause the at least one processor to determine, based at least in part on the information associated with the at least one consumer loyalty account, at least one offer for transmission to the consumer's mobile device or to a point of sale device associated with the merchant.

One or more technical solutions can be achieved by certain embodiments of the disclosure. For example, in at least one embodiment, merchant identification and consumer transaction information associated with a purchase from a particular merchant location can be communicated to a loyalty account associated with the consumer. Based at least in part on the merchant identification, consumer transaction information and/or loyalty account information, an offer, advertising, and/or a discount can be transmitted to a consumer's mobile device and/or merchant point-of-sale device during the purchase transaction at the merchant location. Increased merchant revenue and/or consumer loyalty can result.

These and other embodiments of the disclosure will be described in more detail through reference to the accompanying drawings in the detailed description of the disclosure that follows. This brief introduction, including section titles and corresponding summaries, is provided for the reader's convenience and is not intended to limit the scope of the claims or the proceeding sections. Furthermore, the techniques described above and below may be implemented in a number of ways and in a number of contexts. Several example implementations and contexts are provided with reference to the following figures, as described below in more detail. However, the following implementations and contexts are but a few of many.

### Illustrative Embodiments

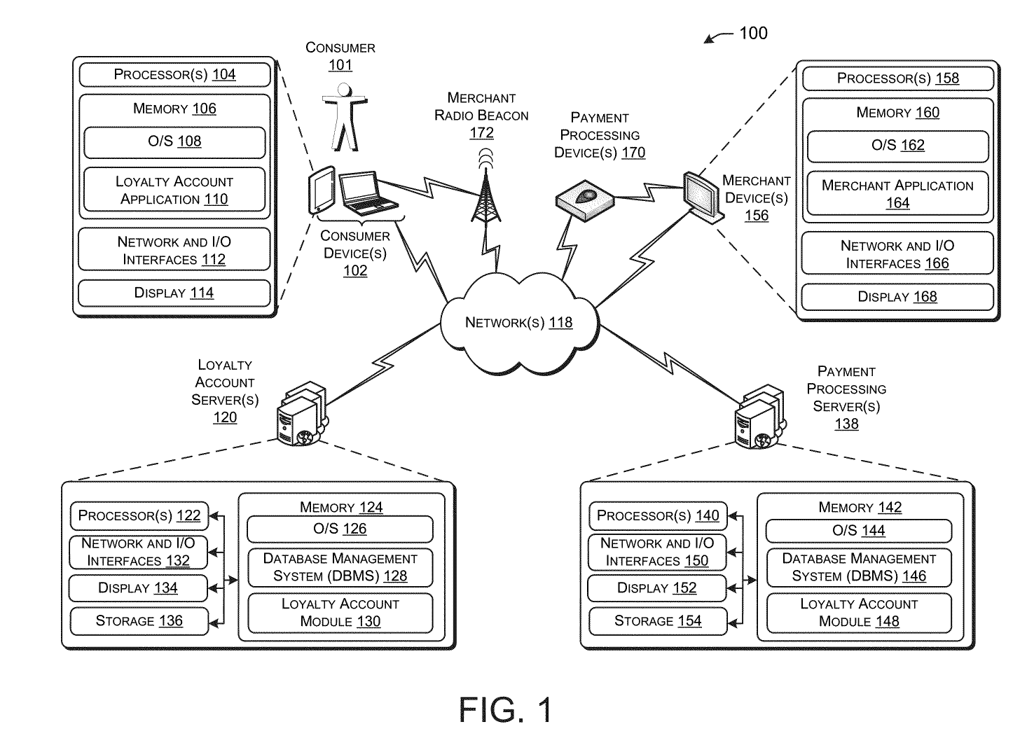

With reference now to FIG. 1, an example system 100 for managing loyalty accounts is shown according to one or more embodiments of the disclosure. The system 100 may include one or more consumer device(s) 102 associated with a consumer, such as 101. The consumer device(s) 102 may be in communication, via one or more networks 118, with one or more loyalty account servers 120, one or more payment processing servers 138, one or more merchant devices 156, one or more payment processing devices 170, and/or one or more merchant radio beacons 172.

In general, the consumer device 102 may refer to any type of electronic device, and, more particularly, may refer to one or more of the following: a wireless communication device, a portable electronic device, a telephone (e.g., cellular phone, smart phone), a computer (e.g., laptop computer, tablet computer), a wearable computer device, a portable media player, a personal digital assistant (PDA), or any other electronic device having a networked capability. The consumer device(s) 102 may include one or more computer processors 104, and a memory 106 storing an operating system (O/S) 108 and a loyalty account application 110. In addition, the consumer device(s) 102 may include one or more network and I/O interfaces 112, and a display 114. In certain embodiments, the consumer device(s) 102 may include one or more sensors capable of gathering information associated with a present environment of the consumer device(s) 102, or similar hardware devices, such as a camera, microphone, antenna, a gesture capture or detection device, or Global Positioning Satellite (GPS) device.

The computer processors 104 may include one or more cores and may be configured to access and execute (at least in part) computer-readable instructions stored in the memory 106. The one or more computer processors 104 may include, without limitation: a central processing unit (CPU), a digital signal processor (DSP), a reduced instruction set computer (RISC), a complex instruction set computer (CISC), a microprocessor, a microcontroller, a field programmable gate array (FPGA), or any combination thereof. The consumer device 102 may also include a chipset (not shown) for controlling communications between the one or more processors 104 and one or more of the other components of the consumer device 102. In certain embodiments, the consumer device 102 may be based on an Intel® architecture or an ARM® architecture, and the processor(s) and chipset may be from a family of Intel® processors and chipsets. The one or more processors 104 may also include one or more application-specific integrated circuits (ASICs) or application-specific standard products (ASSPs) for handling specific data processing functions or tasks.

The memory 106 may include one or more computer-readable storage media (CRSM). In some embodiments, the memory 106 may include non-transitory media such as random access memory (RAM), flash RAM, magnetic media, optical media, solid state media, and so forth. The memory 106 may be volatile (in that information is retained while providing power) or non-volatile (in that information is retained without providing power). Additional embodiments may also be provided as a computer program product including a transitory machine-readable signal (in compressed or uncompressed form). Examples of machine-readable signals include, but are not limited to, signals carried by the Internet or other networks. For example, distribution of software via the Internet may include a transitory machine-readable signal. Additionally, the memory 106 may store an operating system 108 that includes a plurality of computer-executable instructions that may be implemented by the computer processor to perform a variety of tasks to operate the interface(s) and any other hardware installed on the consumer device 102. The memory 106 may also store content that may be displayed by the consumer device 102 or transferred to other devices (e.g., headphones) to be displayed or played by the other devices. The memory 106 may also store content received from the other devices. The content from the other devices may be displayed, played, or used by the consumer device 102 to perform any necessary tasks or operations that may be implemented by the computer processor or other components in the consumer device 102.

The memory 106 may also include an operating system (O/S) 108, which may provide an interface between other application software executing on the consumer device 102 and hardware resources of the consumer device 102. More specifically, the operating system 108 may include a set of computer-executable instructions for managing hardware resources of the consumer device 102 and for providing common services to other application programs (e.g., managing memory allocation among various application programs). The operating system 108 may include any operating system now known or which may be developed in the future including, but not limited to, any consumer operating system, any server operating system, any mainframe operating system, or any other proprietary or freely available operating system.

The memory 106 may also include a loyalty account application 110, which may be configured to enable a consumer's or user's access to one or more loyalty accounts the consumer 101 may have with different merchants. As used herein, a loyalty account may include information associated with a consumer's activity with a merchant, such as purchase history, loyalty account points, redeemable coupons, redeemed coupon history, merchant offers, progress toward a loyalty account prize/offer, and/or the like. In certain embodiments, the loyalty account application 110 may be configured to receive location information, merchant identifier(s), and/or other types of information associated with a merchant, from a merchant radio beacon 172. Based at least in part on such information, the loyalty account application may be configured to determine, identify, and/or otherwise access one or more loyalty accounts associated with the consumer 101. In some embodiments, the loyalty account application 110 may also be configured to determine one or more gift cards and/or gift card balances associated with the consumer 101 and the merchant identified by the merchant identifier. Such gift cards may be applied to one or more purchase transactions with the merchant.

The one or more network and I/O interfaces 112 may include one or more communication interfaces or network interface devices to provide for the transfer of data between the consumer device 102 and another device (e.g., network server) via one or more networks, such as 118. The communication interfaces may include, but are not limited to: personal area networks (PANs), wired local area networks (LANs), wireless local area networks (WLANs), wireless wide area networks (WWANs), and so forth. The consumer device 102 may be coupled to the network via a wired connection. However, the wireless system interfaces may include the hardware and software to broadcast and receive messages either using the Wi-Fi Direct Standard (see Wi-Fi Direct specification published in October 2010) and/or the IEEE 802.11 wireless standard (see IEEE 802.11-2007, published Mar. 8, 2007; IEEE 802.11n-2009, published October 2009), or a combination thereof. The wireless system (not shown) may include a transmitter and a receiver or a transceiver (not shown) capable of operating in a broad range of operating frequencies governed by the IEEE 802.11 wireless standards. The communication interfaces may utilize acoustic, radio frequency, optical, or other signals to exchange data between the consumer device 102 and another device, such as an access point, a host computer, a server, a router, a reader device, and the like. The networks 118 may include, but are not limited to, the Internet, a private network, a virtual private network, a wireless wide area network, a local area network, a metropolitan area network, a telephone network, and so forth.

The display 114 may include, but is not limited to, a liquid crystal display, a light-emitted diode display, or an E-Ink™ display as made by E Ink Corp. of Cambridge, Mass. The display 114 may be used to show content to a user in the form of text, images, or video. In certain instances, the display 114 may also operate as a touch screen display that may enable the user to initiate commands or operations by touching the screen using certain finger or hand gestures.

As previously discussed, one or more loyalty account server(s) 120 may also be in communication with the network(s) 118. The loyalty account server(s) 120 may also include a processor 122 and memory 124, which may store an operating system (O/S) 126, a database management system (DBMS) 128, and a loyalty account module 130. The loyalty account server(s) 120 may also include network and I/O interfaces 132, a display 134, and a storage 136. Storage 136 may provide non-transient storage of computer-executable instructions and other data and may include removable storage and/or non-removable storage including, but not limited to, magnetic storage, optical disk storage, and/or tape storage. The storage 136 may include storage that is internal and/or external to the loyalty account server(s) 120.

The DBMS 128 stored in memory 124 may be configured to support functionality for accessing, retrieving, storing, and/or manipulating data stored in external datastore(s), data stored in the memory 124, and/or data stored in the data storage 136. For example, the DBMS 128 may be configured to retrieve and/or otherwise access loyalty account data associated with the consumer 101. The DBMS 128 may use any of a variety of database models (e.g., relational model, object model, etc.) and may support any of a variety of query languages.

The loyalty account module 130 may be configured to store, retrieve, access, and/or otherwise provide loyalty account data associated with various loyalty accounts and consumers. As such, the loyalty account module 130 may keep track of one or more loyalty accounts (e.g., for different merchants) associated with the consumer 101. For instance, the loyalty account module 130 may be configured to receive (e.g., from the loyalty account application 110 on the consumer device 102) consumer information, such as a consumer identifier associated with the consumer 101, and a merchant identifier. In some embodiments, the loyalty account module 130 may use at least a portion of the received consumer information, (e.g., the consumer identifier associated with the consumer) to identify one or more offers to present to the consumer 101. In some embodiments, the loyalty account module 130 may use at least a portion of merchant information (e.g., merchant identifier) in combination with the consumer information to identify one or more offers to present to the consumer 101. In some embodiments, the consumer information may be associated with a group that is eligible to receive an offer. In some embodiments, the loyalty account module 130 may use the consumer information and/or merchant information to look up any available offers in a table of offers. The table of offers may track loyalty accounts that are eligible for one or more offers and/or has already consumed (e.g., use) and offer. Thus, based at least in part on the consumer identifier and the merchant identifier, the loyalty account module 130 may determine one or more offers to present to the consumer 101.

Furthermore, in certain implementations, the loyalty account module 130 may be configured to determine or otherwise identify, based at least in part on the consumer identifier and/or the merchant identifier, one or more gift cards associated with the consumer 101. The consumer 101 may be able to apply one or more particular gift cards to one more purchase transactions with the merchant associated with the merchant identifier. To this end, the amount applied to the purchase transaction may be deducted from the respective gift card balances associated with the gift cards. In some embodiments, the loyalty account module 130 may use at least a portion of the received consumer information, (e.g., the consumer identifier associated with the consumer) to identify one or more gift cards associated with the consumer 101. In some embodiments, the loyalty account module 130 may use at least a portion of merchant information (e.g., merchant identifier) in combination with the consumer information to identify one or more gift cards associated with the consumer 101. In some embodiments, the loyalty account module 130 may use the consumer information and/or merchant information to look up any available gift cards associated with the consumer in a table (or other data structure) of gift cards. The table of gift cards may track one or more gift cards associated with a loyalty account.

As previously discussed, one or more payment processing server(s) 138 may also be in communication with the network(s) 118. The payment processing server(s) 138 may also include processor(s) 140 and memory 142, which may store an operating system (O/S) 144, a database management system (DBMS) 146, and a loyalty account payment module 148. The payment processing server(s) 138 may also include network and I/O interfaces 150, a display 152, and a storage 154. Storage 154 may provide non-transient storage of computer-executable instructions and other data and may include removable storage and/or non-removable storage including, but not limited to, magnetic storage, optical disk storage, and/or tape storage. The storage 154 may include storage that is internal and/or external to the payment processing server(s) 138.

The DBMS 146 stored in memory 142 may be configured to support functionality for accessing, retrieving, storing, and/or manipulating data stored in external datastore(s), data stored in the memory 142, and/or data stored in the data storage 154. For example, the DBMS 146 may be configured to retrieve and/or otherwise access loyalty account data associated with the consumer 101. The DBMS 146 may use any of a variety of database models (e.g., relational model, object model, etc.) and may support any of a variety of query languages.

The loyalty account payment module 148 may be configured to store, retrieve, access, and/or otherwise provide loyalty account data to facilitate one or more payment transactions associated with the consumer 101 and a merchant. For instance, the loyalty account payment module 148 may be configured to receive consumer information, such as a consumer identifier, associated with the consumer 101. In addition, the loyalty account payment module 148 may be configured to receive payment information associated with a payment transaction associated with the consumer 101. Based at least in part on the consumer identifier and/or the payment information, the loyalty account payment module 148 may be configured to correlate the payment transaction with one or more loyalty accounts associated with the consumer 101. For example, the loyalty account payment module 148 may receive information associated with a payment transaction and may identify the consumer associated with the payment transaction. In some embodiments, the loyalty account payment module 148 may identify one or more loyalty accounts associated with the consumer 101. In some embodiment, the loyalty account payment module 148 may extract payment information (e.g., credit card number, bank account number, billing address, digital wallet information, etc.) from the payment transaction and may store the payment information in association with the loyalty account of the consumer 101. In certain implementations, the loyalty account payment module 148 may also be configured to determine, adjust, redeem, and/or otherwise apply, based at least in part on the loyalty account information, one or more discounts and/or offers to the payment transaction.

It will be appreciated that while the loyalty account server(s) 120 and the payment processing server(s) 138 are illustrated as separate components, in other embodiments, the functionality of both servers may be incorporated into a single server and/or group of servers.

As previously discussed, one or more merchant device(s) 156 may also be in communication with the network(s) 118. The merchant device(s) 156 may also include processor(s) 158 and memory 160, which may store an operating system (O/S) 162 and a merchant application 164. The merchant device(s) 156 may also include network and I/O interfaces 166 and a display 168. Furthermore, the merchant device(s) 156 may be in communication with a payment processing device 170, either directly and/or via the network(s) 118.

In certain implementations, the merchant application 164 may be configured to communicate with the payment processing device(s) 170 in order to facilitate one or more purchase transactions between the consumer 101 and a merchant associated with the merchant device(s) 156. To this end, the merchant application 164 may be configured to transmit and/or otherwise provide information associated with the one or more purchase transactions to the payment processing server(s) 138 and/or the loyalty account server(s) 120.

The payment processing device(s) 170 may be any electronic device capable of receiving payment information from a consumer 101, consumer device 102, merchant device 156, and/or any other devices. For instance, the payment processing device(s) 170 may be capable of receiving information via a magnetic strip on a card (e.g., a loyalty account card, a credit card, etc.) associated with the consumer 101. As another example, the payment processing device(s) 170 may also be configured to receive information via one or more NFC chips associated with the consumer 101. In yet other implementations, the payment processing device(s) 170 may receive payment information via manual entry.

The merchant radio beacon 172 may be a transmission-type device configured to periodically broadcast information associated with the merchant. Various types of wireless technology may be employed to broadcast such information, including, but not limited to, Bluetooth, Bluetooth Low-Energy, Wi-Fi, NFC, Radio Frequency Identification (RFID), infrared, Long-Term Evolution (LTE), and/or LTE-Advanced. As previously discussed, the broadcasted information may include a merchant identifier, location information (e.g., Global Positioning Satellite information, Wi-Fi Positioning System information, etc.), and/or any other type of information associated with the merchant. In certain embodiments, one or more merchant radio beacons 172 may be placed throughout a merchant location or retail store to periodically transmit the broadcasted information.

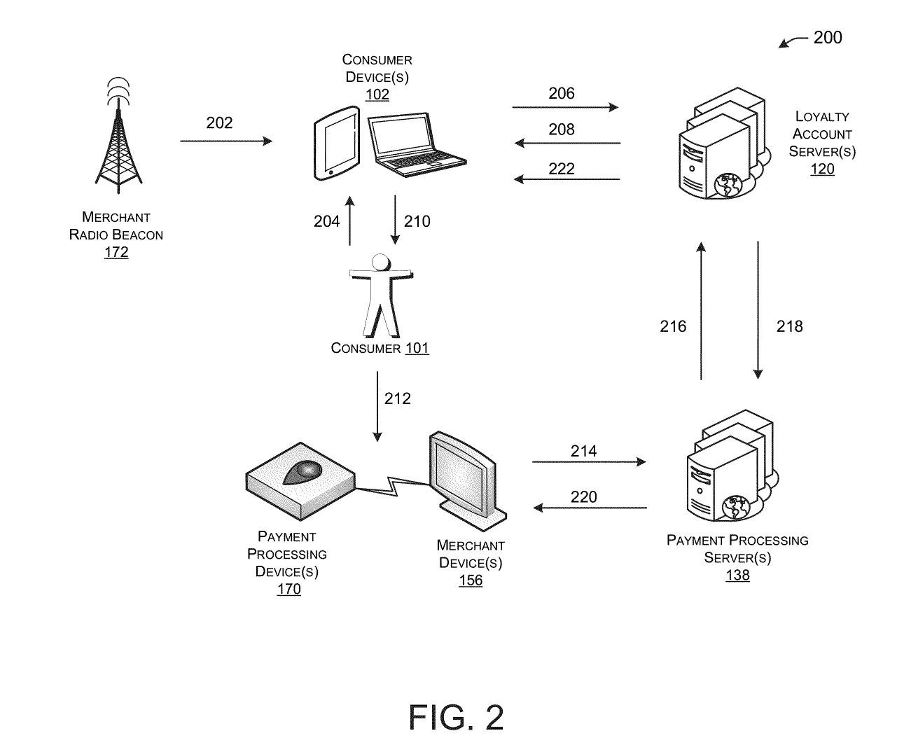

Referring now to FIG. 2, a diagram of an example data flow 200 is illustrated for managing loyalty accounts in accordance with one or more example embodiments. According to the data flow 200, a merchant radio beacon, such as 172 in FIG. 1, may be configured to periodically broadcast 202 information associated with a merchant. In certain implementations, the broadcast information may include a merchant identifier although other types of information are also possible such as a store identifier, location information, and/or the like. A consumer device, such as 102 in FIG. 1, may be configured to receive the broadcast information (e.g., the merchant identifier).

In certain embodiments, upon receipt of the merchant identifier, the consumer device 102 may be configured to “wake-up” and/or launch a loyalty account application, such as 110 in FIG. 1. As such, the loyalty account application 110 may be configured to receive 204 consumer information from the consumer (e.g., a consumer identifier, consumer login and/or password, and/or the like). Alternatively, the consumer information may be already stored on the consumer device 102, and the loyalty account application 110 may be configured to automatically access the consumer information. Upon determination of the merchant identifier and the consumer information, the consumer device 102 may be configured to transmit 206 merchant identifier and/or the consumer information to the loyalty account server(s) 120.

According to one or more embodiments, the loyalty account server(s), such as 120 in FIG. 1 (e.g., via the loyalty account module 130) may be configured to determine, based at least in part on the merchant identifier, location information associated with the consumer, such as 101 in FIG. 1, and/or the consumer device 102, one or more offers to present to the consumer. For example, the merchant identifier may be associated with a particular store and/or a particular store location. Furthermore, the merchant identifier may also be associated with a particular merchant. The loyalty account server(s) 120 may be configured to determine, based at least in part on the consumer information and the merchant identifier, information associated with a loyalty account of the consumer 101. For example, the loyalty account server(s) 120 may retrieve information associated with consumer using consumer information (e.g., name, phone number, email address, etc.) and a merchant identifier. In some embodiments, the loyalty account server(s) 120 may identify one or more loyalty accounts associated with the consumer 101 and retrieve information associated with the one or more loyalty accounts. The loyalty account may represent a loyalty account the consumer 101 has with the particular merchant associated with the merchant identifier. To this end, the loyalty account server(s) 120 may be configured to determine, based at least in part on the information associated with the loyalty account, one or more offers for the consumer 101 for the identified merchant. The loyalty account server(s) 120 may identify offers associated with a consumer and retrieve, from the identified offers, those offers for the identified merchant using the merchant identifier associated with the merchant. In some embodiments, the loyalty account server(s) 120 may retrieve information associated with the loyalty account, consumer, and/or merchant from one or more data structures (e.g., tables, lists, etc.). In some embodiments, the data structures may be stored on one or more datastores. Upon this determination, the loyalty account server(s) 120 may be configured to transmit 208 the least one offer to the consumer device 102. The transmission may include, but is not limited to, a simple messaging service (SMS) message, an instant message, a text message, an email, or transmitting offer information to the loyalty account application 110 on the consumer device 102. The consumer device 102 may then be configured to display 210 and/or otherwise provide the one or more offers to the consumer 101.

As previously discussed, the one or more offers may be associated with various types of information. For example, the one or more offers may be a coupon indicating that the consumer 101 is to receive a free item and/or product (e.g., a free drink). The one or more offers may also include advertised discounts to the consumer (e.g., buy 1 get 1 free, 50% off purchase, etc.). In some implementations, the one or more offers may indicate that the consumer 101 possesses a gift card that may be applied to a purchase transaction with the merchant associated with the merchant radio beacon 172. Furthermore, the loyalty account application 110 may prompt the user to select whether the user desires to redeem, use, accept, and/or otherwise apply the one or more offers to a purchase transaction with the merchant. This selection may be transmitted to and/or stored on the loyalty account server(s) 120, and may be associated with a time limit. If a purchase transaction between the consumer 101 (e.g., using determined the loyalty account) and the merchant is not initiated within the time limit, the user selection may expire.

Alternatively, instead of and/or in addition to an offer, status information may be determined (e.g., by the loyalty account server(s) 120) and displayed (e.g., by the consumer device 102) to the consumer 101. For instance, status information may indicate an amount of loyalty points accumulated by the consumer 101 for the loyalty account. As another example, status information may indicate a number of purchases the consumer 101 has made. In yet other implementations, status information may indicate a progress of the consumer 101 toward an offer.

According to one or more embodiments, the consumer 101 may initiate a purchase transaction with the merchant via a payment processing device, such as 170 in FIG. 1, and/or a merchant device, such as 156 in FIG. 1. To this end, the consumer 101 may use a loyalty account card (not pictured) as part of and/or in addition to the payment transaction. For example, in situations where the payment processing device 170 may be a terminal capable of reading a magnetic strip, the consumer 101 may swipe both the loyalty card and a credit card through the payment processing device 170. Regardless, the payment processing device may receive 212 both payment information (e.g., a payment amount, a product or service identifier, etc.) and loyalty account information (e.g., a loyalty account identifier, a consumer identifier, a merchant identifier, and/or any other type of information associated with the loyalty account).

Upon receipt, the merchant device 156 and/or the payment processing device 170 may be configured to transmit 214 the loyalty account information to the payment processing server(s) 138. The loyalty account payment module 148 in the payment processing server(s) 138 may be configured to determine, based at least in part on the loyalty account information, whether any offers and/or advertisement (e.g., offers, discounts, gift cards, etc.) should be applied to the payment transaction. In some embodiments, the loyalty account payment module 148 may use the loyalty account information to retrieve information associated with the loyalty account, such as any offers, discounts, gift cards, or the like. In some embodiments, the loyalty account payment module 148 may maintain information associated with the loyalty account in a data structure, such as a table or list and may retrieve information by querying the data structure using the loyalty account information (e.g., loyalty account identifier, consumer name, consumer phone number, consumer email address, etc.). In certain implementations, in order to facilitate this determination, the payment processing server(s) 138 (e.g., via the loyalty account payment module 148) may be configured to transmit 216 a request to the loyalty account server(s) 120. The request may include the loyalty account information. In response to the request, the loyalty account server(s) 120 may determine whether one or more offers are to be applied to the purchase transaction. For example, the loyalty account module 130 may determine whether there is a user selection to apply one or more offers to a future purchase transaction. Upon a positive determination, the loyalty account server(s) 120 may transmit 218, to the payment processing server(s) 138, one or more offers that are to be applied to the payment transaction.

Upon receipt, the payment processing server(s) 138 may apply the one or more offers to the payment transaction and transmit 220 the one or more offers to the merchant device 156. Alternatively, or in conjunction with transmitting 222 offers to the merchant device 156, one or more offers can be transmitted 222 to the consumer device 102. For example, the one or more offers may include a coupon for a free product or service that is to be provided to the consumer 101. The one or more offers may also include a discount for a product or service that is to be applied to the final payment amount (e.g., a price discount and/or a percentage discount). The one or more offers may also include an advertisement that is to be provided to the consumer 101. For instance, the advertisement may indicate that the consumer 101 may be eligible for certain offers if the consumer 101 meets certain conditions (e.g., purchases $100 worth of products or services, buys a certain quantity of a product or service, etc.). In other implementations, the one or more offers may include a gift card amount that is to be applied to a final price of the payment transaction. For instance, the final price of the payment transaction may be reduced by an amount associated with the gift card. Similarly, the balance of the gift card may also be reduced by the amount, and the new balance may be stored on the loyalty account server(s) 120.

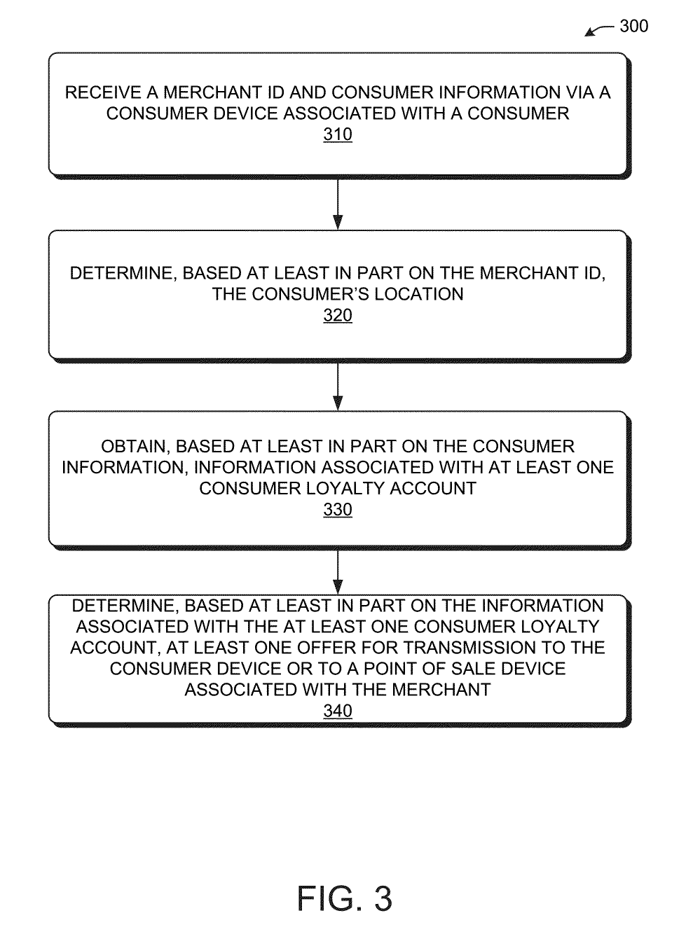

Turning now to FIG. 3, a flow diagram of an example method 300 for managing loyalty accounts is illustrated in accordance with one or more example embodiments. The method may include block 310, in which a server, such as a loyalty account server, such as 120 in FIG. 1, may receive a merchant identifier (ID) and consumer information via a consumer device (e.g., consumer device 102) associated with a consumer (e.g., consumer 101). In block 320, the loyalty account server 120 may determine, based at least in part on the merchant ID, the location of a consumer, such as 101 in FIG. 1. In block 330, the loyalty account server 120 may obtain, based at least in part on the consumer information, information associated with at least one consumer loyalty account. In block 340, the loyalty account server 120 may determine, based at least in part on the information associated with the at least one consumer loyalty account, at least one offer for transmission to the consumer device 102 or to a point of sale device associated with the merchant (e.g., the merchant device 156 and/or the payment processing device 170).

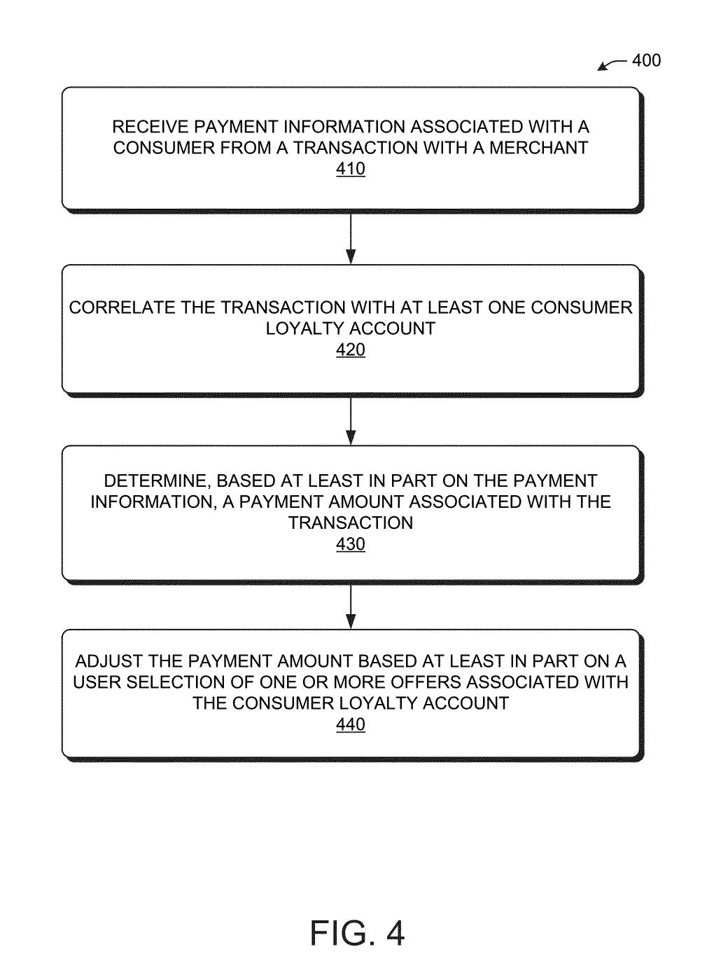

Turning now to FIG. 4, a flow diagram of an example method 400 for managing loyalty accounts is illustrated according to one or more example embodiments. The method 400 may include block 410, in which a server, such as a payment processing server 138 in FIG. 1 may receive payment information associated with a consumer (e.g., consumer 101) from a transaction with a merchant. In block 420, the payment processing server 138 may correlate the transaction with at least one consumer loyalty account. In block 430, the payment processing server 138 may determine, based at least in part on the payment information, a payment amount associated with the transaction. In block 440, the payment processing server 138 may adjust the payment amount based at least in part on a user selection of one or more offers associated with the consumer loyalty account.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

The claimed invention is:

1. A method comprising:
receiving, by a server comprising one or more processors, a merchant ID associated with a merchant and further receiving consumer information associated with a user via a mobile device of the user;
determining, by the server, a location of the user based at least in part on the merchant ID;
obtaining, by the server, information associated with at least one consumer loyalty account based at least in part on the consumer information; and
determining, by the server, at least one offer for transmission to the mobile device of the user or to a point of sale device associated with the merchant.

2. The method of claim 1, further comprising:
receiving, by the server, user input from the mobile device indicative of an acceptance or rejection of the at least one offer.

3. The method of claim 1, further comprising:
receiving, by the server, payment information from a transaction with the merchant and associated with the user; and
correlating, by the server, the transaction with the at least one consumer loyalty account.

4. The method of claim 3, further comprising:
determining, by the server, based at least in part on the payment information, a payment amount associated with the transaction; and
adjusting, by the server, the payment amount based at least in part on a user selection of one or more offers or one or more gift cards associated with the consumer loyalty account.

5. The method of claim 1, further comprising:
receiving, by the server, payment information associated with the user from a transaction with the merchant, wherein at least a portion of the payment information is associated with the at least one consumer loyalty account.

6. The method of claim 1, further comprising at least one of:
transmitting, by the server, the at least one offer to the mobile device of the user; or
transmitting, by the server, the at least one offer to a point of sale device associated with the merchant.

7. The method of claim 6, wherein transmitting the at least one offer to the point of sale device comprises transmitting at least one of a deducted amount for a total bill associated with the user, transmitting a percentage discount for the total bill, transmitting a deducted amount from a gift card balance associated with the user, transmitting a coupon for a discounted or free product or service, or transmitting an advertisement.

8. The method of claim 1, wherein receiving a merchant ID further comprises:
receiving, by the server, the merchant ID via an application executing on the mobile device of the user, wherein the application transmits the merchant ID to at least one loyalty management server or payment processing server.

9. The method of claim 1, wherein receiving consumer information further comprises:
receiving, by the server, the consumer information via an application executing on the mobile device of the user, wherein the application transmits the consumer information to at least one loyalty account server or payment processing server.

10. The method of claim 1, wherein obtaining information associated with the at least one consumer loyalty account further comprises:
retrieving, by the server, previously stored consumer loyalty account information using the received consumer information.

11. A system comprising:
at least one memory storing computer-executable instructions; and
at least one processor, wherein the at least one processor is configured to access the at least one memory and to execute the computer-executable instructions to:
receive a merchant ID associated with a merchant and further receiving consumer information associated with a user via a mobile device of the user;
determine a location of the user based at least in part on the merchant ID;
obtain information associated with at least one consumer loyalty account based at least in part on the consumer information; and
determine at least one offer for transmission to the mobile device of the user or to a point of sale device associated with the merchant.

12. The system of claim 11, wherein the at least one processor is configured to access the at least one memory and to further execute the computer-executable instructions to:
receive user input from the mobile device indicative of an acceptance or rejection of the at least one offer.

13. The system of claim 11, wherein the at least one processor is configured to access the at least one memory and to further execute the computer-executable instructions to:
receive payment information from a transaction with the merchant and associated with the user; and
correlate the transaction with the at least one consumer loyalty account.

14. The system of claim 13, wherein the at least one processor is configured to access the at least one memory and to further execute the computer-executable instructions to:
determine based at least in part on the payment information, a payment amount associated with the transaction; and
adjust the payment amount based at least in part on a user selection of one or more offers or one or more gift cards associated with the consumer loyalty account.

15. The system of claim 11, wherein the at least one processor is configured to access the at least one memory and to further execute the computer-executable instructions to:
receive payment information associated with the user from a transaction with the merchant, wherein at least a portion of the payment information is associated with the at least one consumer loyalty account.

16. The system of claim 11, wherein the at least one processor is configured to access the at least one memory and to further execute the computer-executable instructions to at least one of:
transmit the at least one offer to the mobile device of the user; or
transmit the at least one offer to a point of sale device associated with the merchant.

17. The system of claim 16, wherein, to transmit the at least one offer to the point of sale device, the at least one processor is configured to access the at least one memory and to further execute the computer-executable instructions to:
transmit at least one of a deducted amount for a total bill associated with the user, transmit a percentage discount for the total bill, transmit a deducted amount from a gift card balance associated with the user, transmit a coupon for a discounted or free product or service, or transmit an advertisement.

18. The system of claim 11, wherein, to receive a merchant ID, the at least one processor is configured to access the at least one memory and to further execute the computer-executable instructions to:
receive the merchant ID via an application executing on the mobile device of the user, wherein the application transmits the merchant ID to at least one loyalty management server or payment processing server.

19. The system of claim 11, wherein, to receive consumer information, the at least one processor is configured to access the at least one memory and to further execute the computer-executable instructions to:
receive the consumer information via an application executing on the mobile device of the user, wherein the application transmits the consumer information to at least one loyalty account server or payment processing server.

20. The system of claim 11, wherein, to obtain information associated with the at least one consumer loyalty account, the at least one processor is configured to access the at least one memory and to further execute the computer-executable instructions to:
retrieve previously stored consumer loyalty account information using the received consumer information.
